(19) United States
(12) Patent Application Publication
(10) Pub. No.: US 2011/0067299 A1
(43) Pub. Date: Mar. 24, 2011

(54) INDIVIDUAL MAUSOLEUM FLORAL ARCH

(76) Inventors: Tyvonne Tilley, Bedford, KY (US); Jamie Tilley, Bedford, KY (US)

(21) Appl. No.: 12/887,505

(22) Filed: Sep. 21, 2010

Related U.S. Application Data
(60) Provisional application No. 61/244,110, filed on Sep. 21, 2009.

(51) Int. Cl. A61G 99/00; A47G 7/02

(52) U.S. Cl. 47/41.01

(57) ABSTRACT

A memorial floral arrangement stand which includes an H-shaped frame having a pair of vertical ground penetrating stakes and a horizontal cross arm between the pair of vertical ground penetrating stakes. A decorative arch is affixed to and extends across top ends of the vertical ground penetrating stakes. A mechanism is attached onto the horizontal cross arm for holding a display of flowers above the ground, so as to prevent the display of flowers from being blown away.

### CROSS-REFERENCE TO RELATED APPLICATION

This application claims the benefit of Provisional Patent Application No. 61/244,110, filed on Sep. 21, 2009, in the United States Patent & Trademark Office, the disclosure of which is incorporated herein by reference.

### BACKGROUND OF THE INVENTION

1. Field of the Invention

The present invention relates to a flower display holder, and more particularly, a memorial floral arrangement stand. The memorial floral arrangement stand offers a person an efficient way to place flowers at a grave site or at a flat headstone grave marker without worrying that the flowers will be blown away from the area. The memorial floral arrangement stand can assist the person in leaving flowers for a departed loved one at the grave site or the flat headstone grave marker without worrying that their token of affection will be wasted.

2. Description of the Prior Art

When loved ones pass away, survivors may often place flowers near a headstone. Large flower arrangements, fresh and artificial, can easily be blown over by the wind. This may be upsetting to see when an individual returns to a grave site. Flowers can easily be displaced by the wind, which may create an unkempt scene that may be bothersome to visitors. Purchasing replacement flowers may be expensive. Vases near or built-into pillow top graves that are left empty may give the impression that survivors have forgotten to visit the grave site. Having a sturdy holder that can be inserted into the ground to hold flowers and arrangements may assist individuals in keeping the area near the headstone decorated and clean with little effort while leaving flowers in memoriam for a loved one.

Numerous innovations for ornamental grave site structures have been provided in the prior art that will be described. Even though these innovations may be suitable for the specific individual purposes to which they address, however, they differ from the present invention.

A FIRST EXAMPLE, U.S. Pat. No. 3,809,345, Issued on May 7, 1974, to Tebbe et al. teaches a stand upon which can be placed floral arrangements such as wreaths, sprays and the like for decorating a burial site such as a coffin, grave or tomb has at least two frames mutually connected so as to be positionable over the burial site, each of the frames having a surface for supporting the floral arrangements above the burial site.

A SECOND EXAMPLE, U.S. Pat. No. 4,640,045, Issued on Feb. 3, 1987, to Nesbitt et al. teaches a saddle adapted to be attached to a top portion of a grave marker and having a clamp attached to the bottom thereof for selectively securing the saddle to such grave marker or tombstone. A structure for holding decorative objects such as a planter box for holding flowers or the like is attached to the saddle whereby decorative objects can be displayed on a tombstone or other grave marker and are held up out of the way from lawnmowers or other cemetery trimming machines.

A THIRD EXAMPLE, U.S. Pat. No. 5,072,542, Issued on Dec. 17, 1991, to Quackenbush teaches a saddle planter adapted to be mounted on a gravestone. The saddle planter includes a container including clips to attach the container to a second container for expanding the size of the floral display. The saddle planter also includes mounting brackets that are slidably attached to the container from the underside of the container. The brackets include resilient legs or gripping members at the ends of the legs. The legs are adapted to supply horizontal forces to the front and rear of the gravestone. The brackets include cushioned pads or gripping members which contact the front and rear surfaces of the gravestone, thereby supplying vertical frictional gripping forces. The pads prevent scarring and marking of the gravestone due to the force applied by the bracket to the surface of the gravestone, as well as creating a high friction contact with the gravestone surfaces.

A FOURTH EXAMPLE, U.S. Pat. No. 6,662,492, Issued on Dec. 16, 2003, to Oliver teaches a garden memorial arch floral material holder that is installed in a cemetery with two ground penetrating stake assemblies and a flora holding assembly. The flora holding assembly comprises a plurality of rods connected in tandem and the rods have sufficient flexibility to elastically deform from an unstressed straight linear aspect to an arcuate aspect encompassing a semi-circular arch configuration, without permanent deformation. Rods of different length may be connected in different combinations to provide different arch assembly lengths. The rod connections have abutments limiting telescopic overlapping and friction detents to resist disconnection. Each of the two stake assemblies has a horizontal brace portion to be engaged by foot to force a stake portion into a cemetery ground, to engage the ground to limit the penetration, and to provide vertical alignment. The stake assemblies are in spaced apart parallel planes that are perpendicular to the arch assembly to stabilize the holder.

A FIFTH EXAMPLE, U.S. Patent Office Publication No. 2005/0155197, Published on Jul. 21, 2005, to Hunter teaches a grave site cover comprising a snap together heavy plastic tube frame, fittings and couplings, an artificial turf cover, transparent identification insert and anchor stakes. The artificial turf cover is rolled over and along the outside frame edge, and attached with self tapping stainless steel flange head screws. Three and four way fittings are provided at all four corners for inserting the ground anchor stakes, additional fittings are provided at the center point and head marker for inserting ground anchor stakes, used for securely holding the grave site cover in place. The artificial turf grave cover may be fabricated in a variety of colors, with images, text, art or other decor. A grave site cover that can be hand assembled and easily installed, that is weather resistant, durable and economical to manufacture, thereby providing a neat, dignified, maintenance free and durable grave site cover.

A SIXTH EXAMPLE, U.S. Patent Office Publication No. 2007/0245624, Published on Oct. 25, 2007, to Padden teaches an outdoor and garden structure for displaying ornamental items which permits people to express themselves in an outdoor environment. The outdoor and garden structure includes a pair of laterally spaced uprights secured to the ground in a vertical orientation, and a plurality of cross members disposed laterally between the uprights. At least one of the cross members may be provided with an anchor for suspending an ornamental item within an opening defined by the uprights, the cross member and an adjacent cross member. A shelf may be attached to and positioned on an upper surface of a cross member for supporting an ornamental item within an opening on the cross member. The outdoor and garden structure may further include a cap member positioned adjacent and extending laterally between the uprights. The cap member may include a pair of transversely spaced headers and a plurality of lattices extending transversely between the headers.

It is apparent now that numerous innovations for ornamental grave site structures have been provided in the prior art that are adequate for various purposes. Furthermore, even though these innovations may be suitable for the specific individual purposes to which they address, accordingly, they would not be suitable for the purposes of the present invention as heretofore described.

### SUMMARY OF THE INVENTION

AN OBJECT of the present invention is to provide a memorial floral arrangement stand that avoids the disadvantages of the prior art.

ANOTHER OBJECT of the present invention is to provide a memorial floral arrangement stand that is simple and inexpensive to manufacture.

STILL ANOTHER OBJECT of the present invention is to provide a memorial floral arrangement stand that is simple to use.

BRIEFLY STATED, STILL YET ANOTHER OBJECT of the present invention is to provide a memorial floral arrangement stand which comprises an H-shaped frame having a pair of vertical ground penetrating stakes and a horizontal cross arm between the pair of vertical ground penetrating stakes. A decorative arch is affixed to and extends across top ends of the vertical ground penetrating stakes. A mechanism is attached onto the horizontal cross arm for holding a display of flowers above the ground, so as to prevent the display of flowers from being blown away.

The novel features which are considered characteristic of the present invention are set forth in the appended claims. The invention itself, however, both as to its construction and its method of operation, together with additional objects and advantages thereof, will be best understood from the following description of the specific embodiments when read and understood in connection with the accompanying drawing.

### BRIEF DESCRIPTION OF THE DRAWING

The figures of the drawings are briefly described as follows:

FIG. 1 is a perspective view of the present invention showing a stand in use, placed over a grave site;

FIG. 2 is a perspective view of the stand in use placed near a flat headstone grave marker;

FIG. 3 is a perspective view showing two versions of the stand;

FIG. 4 is a perspective view showing the two versions of the stand, with each holding a display of flowers; and

FIG. 5 is a perspective view showing four stands with four different arches.

### REFERENCE NUMERALS UTILIZED IN THE DRAWING

110 memorial floral arrangement stand
112H-shaped frame of stand 110
114 ground penetrating stake of frame 112
116 cross arm of frame 112
118 decorative arch of stand 110
120 top end of ground penetrating stake 114
122 holding mechanism of stand 110
124 display of flowers
126 ground
128 decoration of decorative arch 118
130 scroll for decoration 128
132 fleur-de-lis for decoration 128
134 heart for decoration 128
136 flower for decoration 128
138 praying hands for decoration 128
140 star for decoration 128
142 trough box of holding mechanism 122
144 flat rectangular plate of holding mechanism 122
146 upstanding rod of holding mechanism 122
148 durable strong non-corrosive material for stand 110
150 steel for material 148
152 plastic for material 148
154 grave site
156 flat headstone grave marker

### DETAILED DESCRIPTION OF THE PREFERRED EMBODIMENT

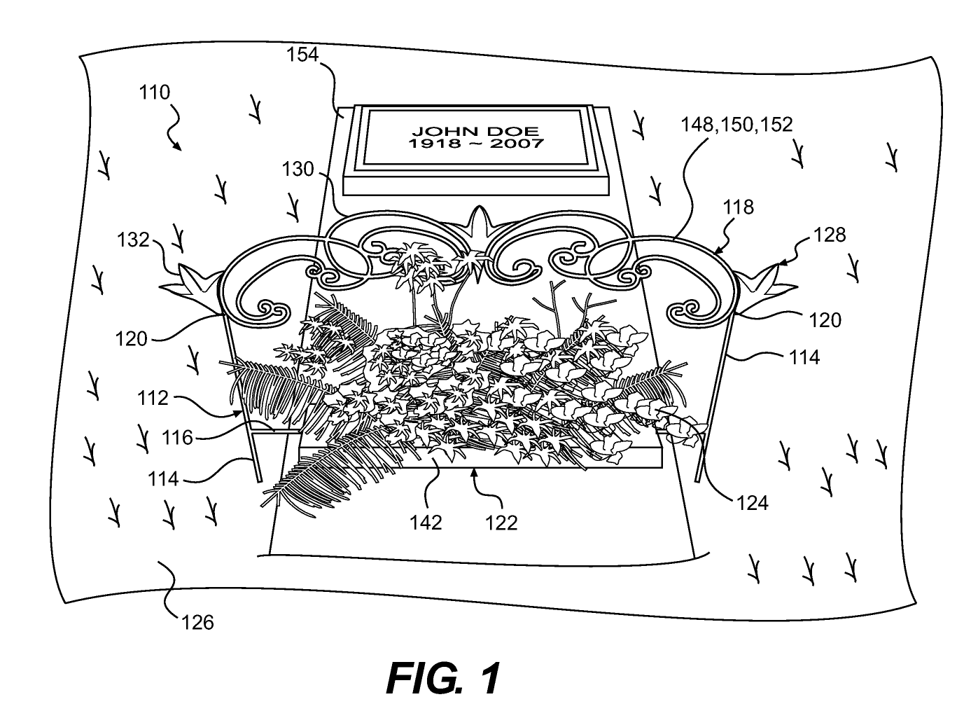

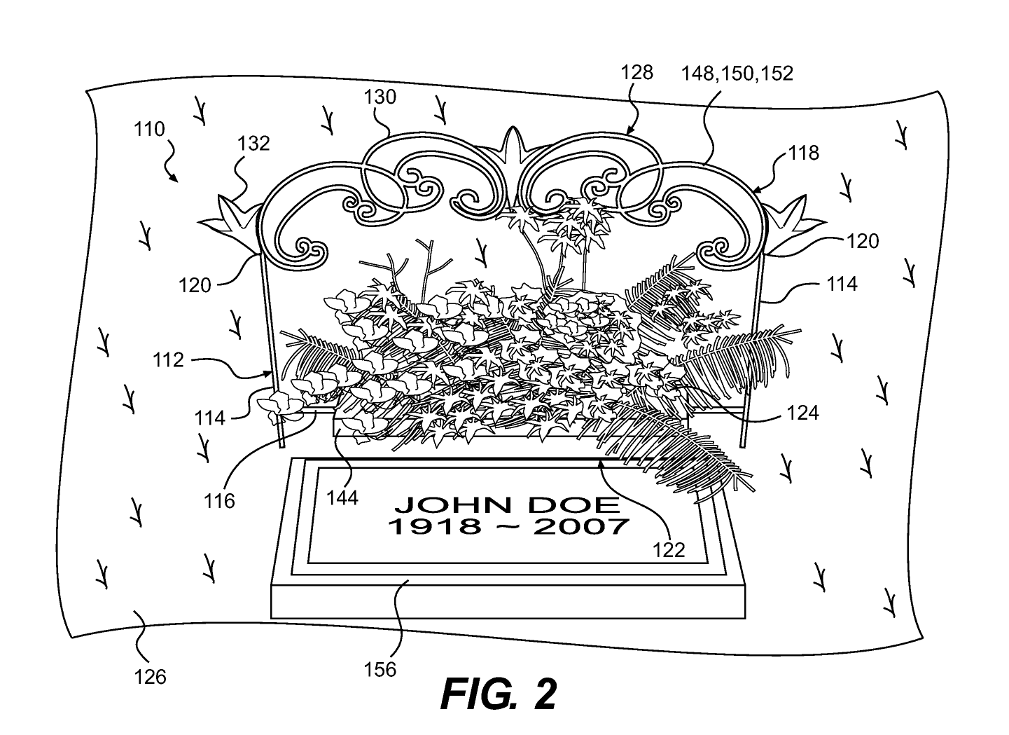

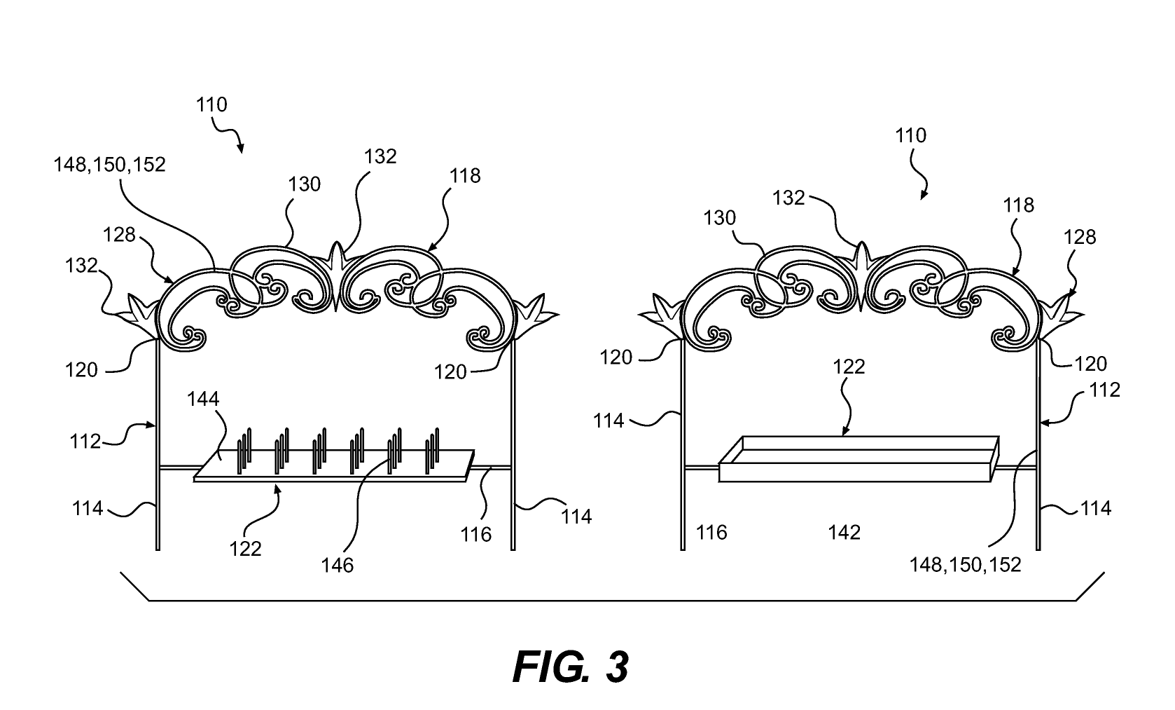

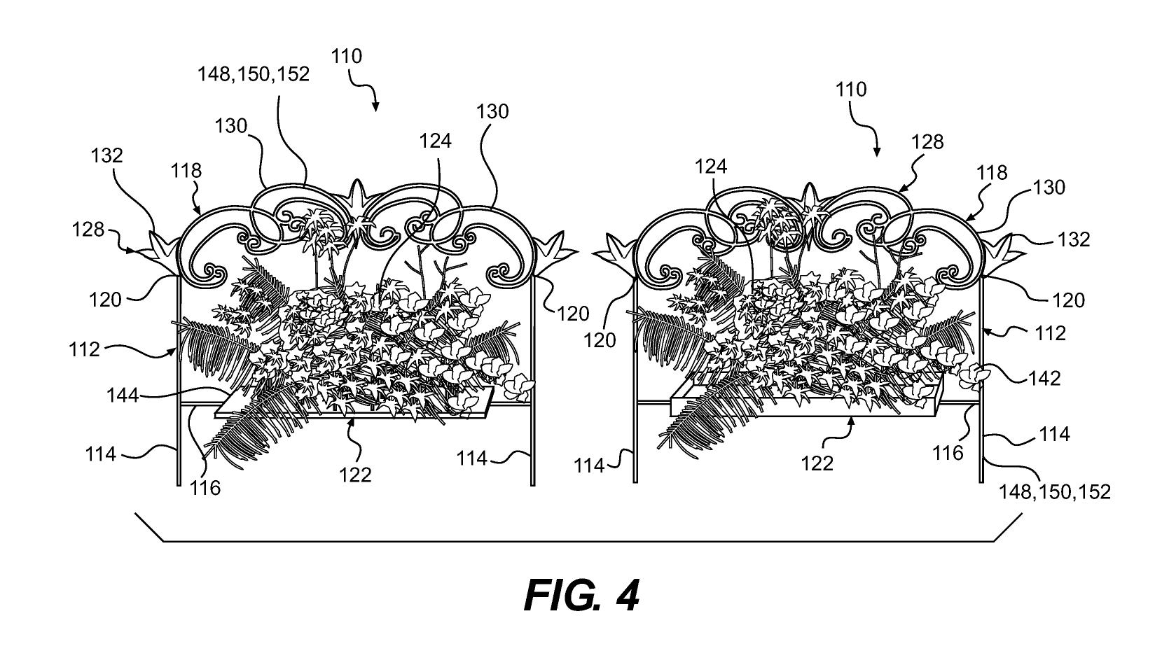

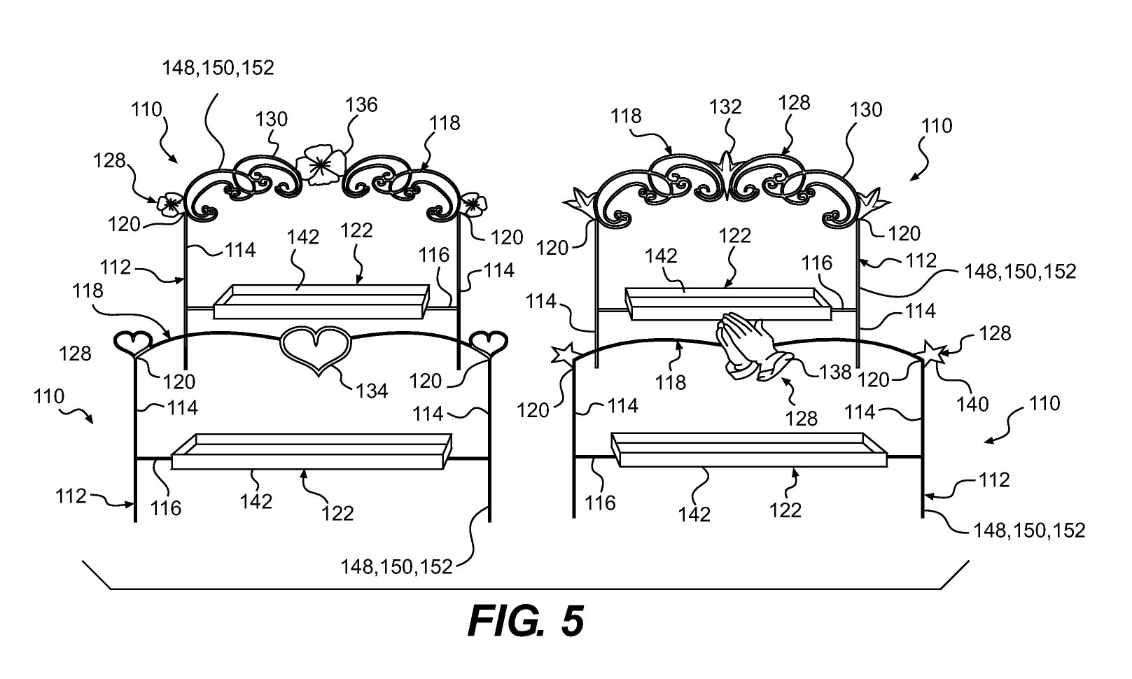

Referring now to the figures, in which like numerals indicate like parts, and particularly to FIGS. 1 through 5, and as such, will be discussed with reference thereto.

The present invention is a memorial floral arrangement stand 110 which comprises an H-shaped frame 112 having a pair of vertical ground penetrating stakes 114 and a horizontal cross arm 116 between the pair of vertical ground penetrating stakes 114. A decorative arch 118 is affixed to and extends across top ends 120 of the vertical ground penetrating stakes 114. A mechanism 122 is attached onto the horizontal cross arm 116 for holding a display of flowers 124 above the ground 126, so as to prevent the display of flowers 124 from being blown away. The length of the horizontal cross arm. 116 is longer than the length of grave marker 156.

The decorative arch 118 comprises a decoration 128 selected from the group consisting of scrolls 130, fleurs-de-lis 132, hearts 134, flowers 136, praying hands 138 and stars 140. The holding mechanism 122 can be comprised of a trough box 142 to maintain the display of flowers 124 in place. The holding mechanism 122 can also be comprised of a flat rectangular plate 144 and a plurality of upstanding rods 146 mounted on the flat rectangular plate 144 to maintain the display of flowers 124 in place.

The H-shaped frame 122, the decorative arch 118 and the holding mechanism 122 is comprised out of a durable strong non-corrosive material 148. The durable strong non-corrosive material 148 is steel 150. The durable strong non-corrosive material 148 can also be plastic 152.

The floral arrangement stand 110 will hold the display of flowers 124 to keep them off of the ground 126 and to prevent them from being blown away at a grave site 154 or a flat headstone grave marker 156. The present invention is comprised of several items to form the H-shape 112. The stand 110 is sized to either straddle the grave site 154 or be placed near the flat headstone grave marker 156. The holding mechanism 122 for the display of flowers 124 can be either the trough box 142, or the flat rectangular plate 144 with the upstanding rods 146 to secure the display of flowers 124 in place. The stand 110 can be available in various styles, designs, colors, finishes and sizes to accommodate user preferences and needs. The decorations 128 of the decorative arch 118 can include, but are not limited to, scrolls 130, fleurs-de-lis 132, hearts 134, flowers 136, praying hands 138 and stars 140. The exact dimensions, materials used for construction and method of operation of the present invention may vary upon manufacturing.

It will be understood that each of the elements described above, or two or more together, may also find a useful application in other types of constructions differing from the types described above.

While the invention has been illustrated and described as embodiments of a memorial floral arrangement stand, accordingly it is not limited to the details shown, since it will be understood that various omissions, modifications, substitutions and changes in the forms and details of the device illustrated and its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute characteristics of the generic or specific aspects of this invention.

The invention claimed is:

1. A memorial floral arrangement stand which comprises:
a) an H-shaped frame having a pair of vertical ground penetrating stakes,
b) an horizontal cross arm between the pair of vertical ground penetrating stakes,
c) a decorative arch affixed to and extending across top ends of the vertical ground penetrating stakes; and
d) means attached onto the horizontal cross arm for holding a display of flowers above the ground, so as to prevent the display of flowers from being blown away.

2. The stand a recited in claim 1, wherein the decorative arch comprises a decoration selected from the group consisting of scrolls, fleurs-de-lis, hearts, flowers, praying hands and stars.

3. The stand as recited in claim 1, wherein the holding means comprises a trough box to maintain the display of flowers in place.

4. The stand as recited in claim 1, wherein the holding means comprises:
a) a flat rectangular plate; and
b) a plurality of upstanding rods mounted on the flat rectangular plate to maintain the display of flowers in place.

5. The stand as recited in claim 1, wherein the H-shaped frame, the decorative arch and the holding means is comprised out of a durable strong non-corrosive material.

6. The stand as recited in claim 5, wherein the durable strong non-corrosive material is steel.

7. The stand as recited in claim 5, wherein the durable strong non-corrosive material is plastic.

8. The stand as recited in claim 1, wherein the horizontal cross arm's length is longer than the grave marker's length.
